(19) United States
(12) Patent Application Publication
(10) Pub. No.: US 2014/0338940 A1
(43) Pub. Date: Nov. 20, 2014

(54) CLUTCH AND HAMMER ASSEMBLIES FOR POWER TOOL

(71) Applicant: Black & Decker Inc., Newark, DE (US)

(72) Inventors: Joseph P. Kelleher, Parkville, MD (US); Daniel L. Krout, Abingdon, MD (US); Seth M. Robinson, Henryville, PA (US); John K. Horky, Lutherville, MD (US); Paul S. White, Ellicott City, MD (US)

(21) Appl. No.: 13/893,612

(22) Filed: May 14, 2013

(51) Int. Cl. B25D 16/00; B25D 11/00

(52) U.S. Cl. CPC B25D 16/003; B25D 11/00
USPC 173/48; 173/213

(57) ABSTRACT

A power tool includes a tool housing, an output spindle, a motor received in the tool housing, a transmission coupled to the motor and configured to transmit torque from the motor to the output spindle, a clutch assembly, and a hammer assembly. The clutch assembly includes a clutch mechanism configured to interrupt torque transmission from the transmission to the output spindle when an output torque exceeds a threshold, and a clutch housing composed of a non-metallic material and supporting at least a portion of the clutch mechanism. The hammer assembly includes a hammer mechanism configured to apply axial impacts to the output spindle when the hammer mechanism is engaged, and a hammer housing composed of a heat conductive material and supporting at least a portion of the hammer mechanism. The hammer housing is at least partially disposed inside of a portion of the clutch housing

### TECHNICAL FIELD

This application relates to a clutch assembly and a hammer assembly for a power tool, e.g., a hammer drill.

### BACKGROUND

A power tool, such as a hammer drill, may include a clutch mechanism and a hammer mechanism disposed between the transmission and the output spindle. A clutch mechanism may be configured to interrupt torque transmission from the transmission to the output spindle when the output torque exceeds a predetermined amount. Examples of certain types of clutch mechanisms can be found in, e.g., U.S. Pat. Nos. 7,066,691 and 8,251,158, which are incorporated by reference. The clutch mechanisms disclosed in these patents generally include a clutch plate that abuts against one or more springs. The springs press one or more locking members (e.g. balls and/or pins) against a clutch face coupled to a portion of the transmission. When the torque overcomes the force exerted by the spring and the locking members, torque transmission from the transmission to the output spindle is reduced or effectively interrupted.

A hammer mechanisms may be configured to selectively impart axial impacts to the output spindle. Examples of certain types of hammer mechanism can be found in e.g., U.S. Pat. Nos. 5,704,433 and 7,314,097, which are incorporated by reference. The hammer mechanisms disclosed in these patents generally include a rotating ratchet wheel that is non-rotationally coupled to the transmission, a stationary ratchet wheel that remains rotationally stationary relative to the housing, and a spring that biases the ratchet wheels apart. When axial bias is applied to the output spindle to overcome the spring force, the ratchet wheels engage and cause axial impacts to be applied to the output spindle.

The clutch mechanisms and the hammer mechanisms of the types disclosed in the above-referenced patents may be supported by a housing portion. The housing may be composed of either a plastic material or a metal material. A housing composed of a plastic material generally is less expensive, more lightweight, and more durable with the clutch mechanism components, but tends to melt or deform from the heat generated by the hammer mechanism, and tends to become worn or abraded when exposed to an exterior of the tool. A housing composed of a metal material generally dissipates heat from the hammer components, and has better wear on the exterior of the tool, but is more expensive, heavier, and is less durable with the clutch components due to galling.

### SUMMARY

In an aspect, a power tool includes a tool housing, an output spindle, a motor received in the tool housing, a transmission coupled to the motor and configured to transmit torque from the motor to the output spindle, a clutch assembly, and a hammer assembly. The clutch assembly includes a clutch mechanism configured to interrupt torque transmission from the transmission to the output spindle when an output torque exceeds a threshold, and a clutch housing composed of a non-metallic material and supporting at least a portion of the clutch mechanism. The hammer assembly includes a hammer mechanism configured to apply axial impacts to the output spindle when the hammer mechanism is engaged, and a hammer housing composed of a heat conductive material and supporting at least a portion of the hammer mechanism. The hammer housing is at least partially disposed inside of a portion of the clutch housing.

Implementations of this aspect may include one or more of the following features. The clutch assembly and the hammer assembly may be disposed between the transmission and the output spindle. The clutch mechanism may include a clutch face fixedly connected to a portion of the transmission, a pressing member selectively engaging the clutch face, and a biasing member configured to bias the pressing member against the clutch face. Torque transmission from the transmission to the output spindle is effectively interrupted when the output torque overcomes a biasing force exerted by the biasing member and the pressing member against the clutch face. The clutch mechanism may further include an adjustment sleeve configured to adjust the biasing force exerted by the biasing member and the pressing member on the clutch face.

The hammer mechanism may include a rotating ratchet wheel fixedly coupled to the output spindle, a stationary ratchet wheel non-rotatably coupled to the hammer housing, and a spring biasing the rotating ratchet wheel away from the stationary ratchet wheel. The stationary ratchet wheel and the rotating ratchet wheel may be configured to engage each other against the force of the spring when axial bias is applied to the output spindle, causing axial impacts to be applied to the output spindle. A cam plate may be configured to selectively axially move at least one of the stationary ratchet wheel and the rotating ratchet wheel to prevent engagement of the stationary ratchet wheel and the rotating ratchet wheel to prevent axial impacts from being applied to the output spindle. At least a portion of the hammer housing may be exposed to an exterior of the power tool.

An annular cap may be disposed over the rear portion of the clutch housing, wherein at least a portion of the annular cap is exposed to an exterior of the power tool. The annular cap may be composed of a metal material. The clutch housing may include a smaller diameter nose portion and a larger diameter base portion, and the hammer housing comprises a larger diameter front portion and a smaller diameter rear portion that is at least partially disposed inside the nose portion of the clutch housing. The non-metallic material may be a plastic material. The heat conductive material may be a metal material.

In another aspect, a power tool includes a tool housing, a motor received in the tool housing, an output spindle at least partially received in the tool housing, a transmission coupled to the motor and configured to transmit torque from the motor to the output spindle, a clutch assembly and a hammer assembly. The clutch assembly includes a clutch housing with a nose portion and a base portion, a clutch face connected to a portion of the transmission, a pressing member configured to selectively engage the clutch face, and a biasing member configured to bias the pressing member against the clutch face. Torque transmission from the transmission to the output spindle is interrupted when an output torque overcomes a biasing force exerted by the biasing member against the pressing member, enabling the clutch face to move relative to the pressing member. The hammer assembly includes a hammer housing with a rear portion at least partially received in the nose portion of the clutch housing and a front portion at least partially exposed to an exterior of the power tool, a rotating ratchet wheel fixedly coupled to the output spindle and received in the rear portion, a stationary ratchet wheel non-rotatably coupled to the hammer housing and received in the rear portion, and a spring biasing the rotating ratchet wheel away from the stationary ratchet wheel. The stationary ratchet wheel and the rotating ratchet wheel are configured to engage each other against the force of the spring when axial bias is applied to the output spindle, causing axial impacts to be applied to the output spindle.

Implementations of this aspect may include one or more of the following features. The clutch housing and the hammer housing may be composed of different materials. The hammer housing is composed of a heat conductive material. The clutch housing may be composed of a plastic material. The rotating ratchet wheel and the stationary ratchet wheel may be nested inside of the nose portion of the clutch housing. An annular cap may be disposed over the base portion of the clutch housing. The annular cap may be at least partially exposed to an exterior of the power tool. The annular cap may be composed of a metal material.

In another aspect, a power tool includes a tool housing, a motor received in the tool housing, an output spindle at least partially received in the tool housing, a transmission coupled to the motor and configured to transmit torque from the motor to the output spindle, a clutch assembly, and an annular cap. The clutch assembly includes a clutch mechanism configured to interrupt torque transmission from the transmission to the output spindle when an output torque exceeds a threshold, and a clutch housing composed of a non-metallic material and supporting at least a portion of the clutch mechanism. The annular cap is disposed over the base portion of the clutch housing. The annular cap is at least partially exposed to an exterior of the hammer drill and is composed of a metal material.

Advantages may include one or more of the following. The clutch housing is inexpensive, lightweight, and durable with the clutch mechanism components, while the hammer housing dissipates heat from the hammer mechanism, preventing melting or deformation of the clutch housing. The portions of the hammer mechanism and the annular cap that are exposed to the exterior of the power tool also resist wear and abrasion and provide additional structural strength and integrity to this portion of the power tool. The annular cap additionally provides a superior substrate for receiving threaded fasteners to attach the cap and clutch housing to the remainder of the power tool, which may reduce the number of fasteners required. These and other advantages and features will be apparent from the description, the drawings, and the claims.

### BRIEF DESCRIPTION OF THE DRAWINGS

FIG. 1 is a perspective view of a hammer drill with a portion of the tool housing removed.

FIG. 2 is a cross-sectional view of the clutch assembly and hammer assembly of the hammer drill of FIG. 1.

FIG. 3 is an exploded perspective view of the transmission and clutch assembly of the hammer drill of FIG. 1.

FIG. 4 is a close-up cross-sectional view of a portion of the transmission of FIG. 1 in a first speed reduction position.

FIG. 5 is a close-up cross-sectional view of a portion of the transmission of FIG. 1 in a second speed reduction position.

FIGS. 6 and 7 are exploded perspective views of the clutch housing, annular cap, and hammer housing of the hammer drill of FIG. 1.

FIG. 8 is a perspective view of the of the clutch housing, annular cap, and hammer housing of the hammer drill of FIG. 1.

FIGS. 9 and 10 are exploded perspective views of the hammer assembly of the hammer drill of FIG. 1.

FIG. 11 is a schematic side view of the hammer assembly of FIG. 1 with the hammer mechanism in a clutch or drill mode.

FIG. 12 is a schematic side view of the hammer assembly of FIG. 1 with the hammer mechanism in a hammer mode, and the ratchet wheels unengaged.

FIG. 13 is a schematic side view of the hammer assembly of FIG. 1 with the hammer mechanism in hammer mode, and the ratchet wheels engaged.

### DETAILED DESCRIPTION

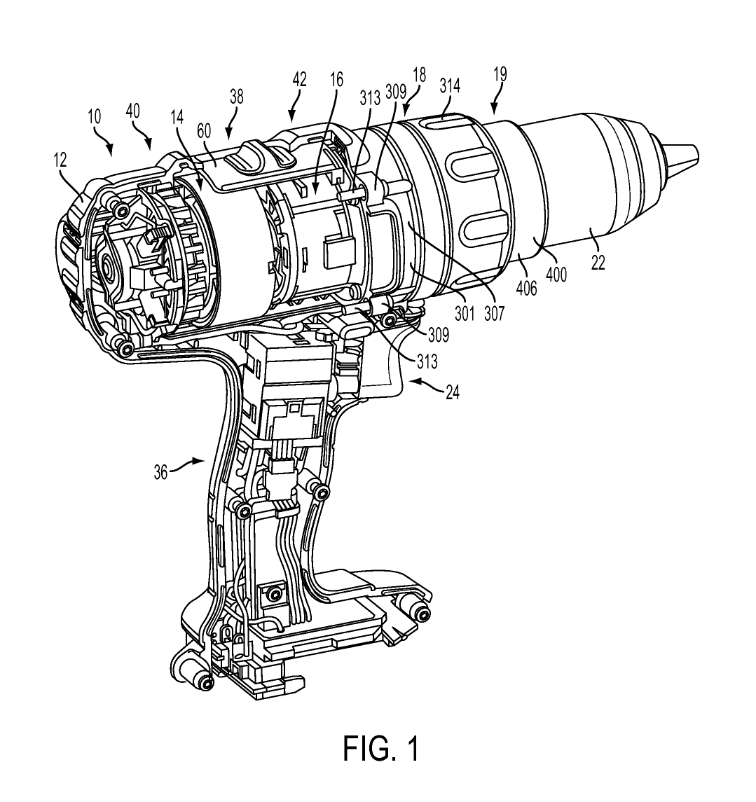

Referring to FIG. 1, a power tool 10 (e.g., a hammer drill) includes a tool housing 12 with a handle portion 36 and a body portion 38. The body portion 38 includes a motor cavity 40 and a transmission cavity 42. Coupled to the handle portion 36 are a trigger assembly 24 and a battery pack (not shown). As those skilled in the art will appreciate, embodiments may also include either a corded (AC) power tool. Received in the motor cavity 40 is a motor assembly 14. At least partially received in the transmission cavity 42 is a multi-speed transmission assembly 16. Coupled to a front end of the transmission cavity 42 are a clutch assembly 18, a hammer assembly 19, an output spindle 20, and a tool holder in the form of a chuck 22. Those skilled in the art will understand that several of the components of the power tool 10, such as the motor assembly 14, the chuck 22, the trigger assembly 24 and the battery pack 26, are conventional in nature and therefore need not be discussed in significant detail in the present application. Reference may be made to a variety of publications for a more complete understanding of the conventional features of the power tool 10. One example of such publications is U.S. Pat. No. 5,897,454 issued Apr. 27, 1999, the disclosure of which is hereby incorporated by reference.

Transmission Assembly

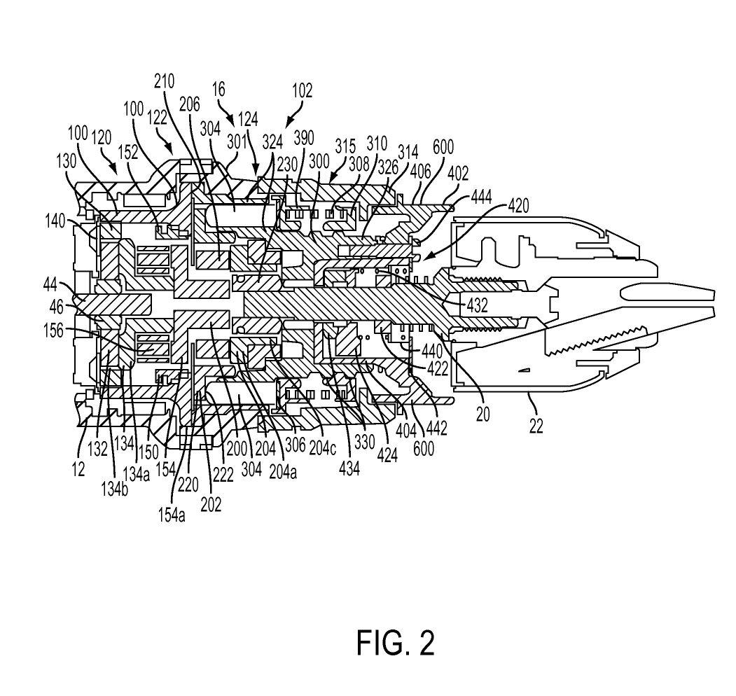

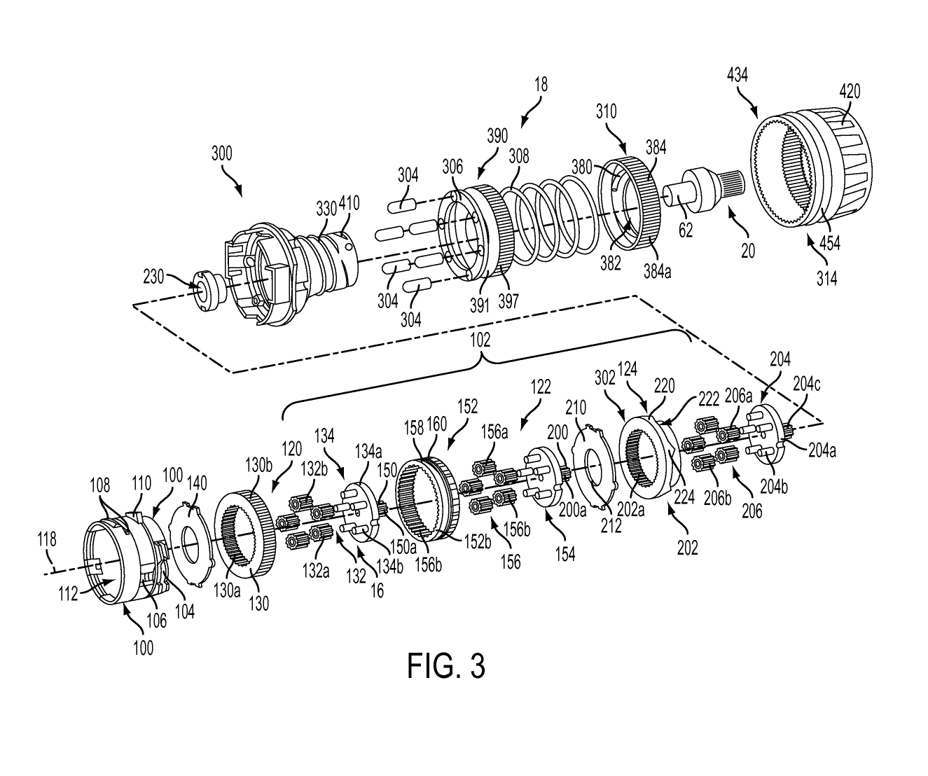

Referring also to FIGS. 2 and 3, the transmission assembly 16 receives a rotary input from an output shaft 44 of the motor assembly 14 via a motor pinion 46, and converts that input to a relatively lower speed, higher torque output that is transmitted to the output spindle 20. The transmission assembly 16 includes a plurality of reduction elements that are selectively engaged to provide a plurality of speed reduction ratios. Each of the speed reduction ratios reduces the speed and increases the torque of the drive input in a predetermined manner, permitting the output speed and torque of the transmission assembly 16 to be varied in a desired manner between a relatively low speed, high torque output and a relatively high speed, low torque output. Rotary power output from the transmission assembly 16 is transmitted to the output spindle 20, to which the chuck 22 is coupled for rotation, to permit torque to be transmitted to a tool bit (not shown).

The transmission assembly 16 includes a three-stage, two-speed gear train 102 disposed in a gear case 100 that is received in the transmission cavity 42. The gear train 102 is illustrated to be a planetary type gear train, having a first planetary gear set 120, a second planetary gear set 122 and a third planetary gear set 124. In the example provided, each of the first, second and third gear sets 120, 122 and 124 are operable in an active mode, wherein the gear set performs a speed reduction and torque multiplication operation, while the second planetary gear set 122 is also operable in an inactive mode, wherein it provides a rotary output having a speed and torque that is about equal to that which is input to it.

The first planetary gear set 120 includes first ring gear 130, a first set of planet gears 132 and a first reduction carrier 134. The first ring gear 130 is an annular structure, having a plurality of gear teeth 130a that are formed about its interior diameter and a plurality of gear case engagement teeth 130b that are formed onto its outer perimeter. With additional reference to FIG. 5, the first ring gear 130 is disposed within the gear case 100 such that the gear case engagement teeth 130b engage mating teeth 130c formed on the inner surface of the gear case 100 to inhibit relative rotation between the first ring gear 130 and the gear case 100. As the gear case engagement teeth 130b terminate prior to the rear face 130d of the first ring gear 130, forward movement of the first ring gear 130 is halted by interference between the mating teeth 130c that are formed on the inner surface of the gear case 100 and the portion of the first ring gear 130 that is disposed rearwardly of the gear case engagement teeth 130b.

The first reduction carrier 134 includes a body 134a, which is formed in the shape of a flat cylinder and a plurality of cylindrical pins 134b that extend from the rearward face of the body 134a. The first set of planet gears 132 includes a plurality of planet gears 132a, each of which being generally cylindrical in shape and having a plurality of gear teeth 132b formed onto its outer perimeter and a pin aperture (not specifically shown) formed through its center. Each planet gear 132a is rotatably supported on an associated one of the pins 132b of the first reduction carrier 134 and is positioned to be in meshing engagement with the gear teeth of the first ring gear 130. A first annular thrust washer 140 is fitted to the end of the gear case 100 proximate the motor assembly 14 and prevents the planet gears 132 from moving rearwardly and disengaging the pins 134b of the first reduction carrier 134. A raised portion 142 is formed onto the front and rear faces of each planet gear 132 to inhibit the gear teeth 132b of the planet gears 132 from rubbing on the first reduction carrier 134 and the first thrust washer 140. The teeth 46a of the motor pinion 46 are also meshingly engaged with the teeth 132b of the planet gears 132 and as such, the motor pinion 46 serves as the first sun gear for the first planetary gear set 120.

The second planetary gear set 122 is disposed within the central cavity 112 forward of the first planetary gear set 120 and includes a second sun gear 150, a second ring gear 152, a second reduction carrier 154 and a second set of planet gears 156. The second sun gear 150 is fixed for rotation with the first reduction carrier 134 and includes a plurality of gear teeth 150a that extend forwardly from the flat, cylindrical portion of the first reduction carrier 134. The second ring gear 152 is an annular structure having a plurality of gear teeth 152a formed about its interior diameter, an annular clip groove 158 formed into its outer perimeter and a plurality of gear case engagement teeth 160 that are formed onto its outer perimeter.

The second reduction carrier 154 includes a body 154a, which is formed in the shape of a flat cylinder, and plurality of pins 154b that extend from the rearward face of the body 154a. The second set of planet gears 156 is shown to include a plurality of planet gears 156a, each of which being generally cylindrical in shape and having a plurality of gear teeth 156b and a pin aperture in its center. Each planet gear 156a is supported for rotation on an associated one of the pins 154b of the second reduction carrier 154 and is positioned such that the gear teeth 156b are in meshing engagement with gear teeth 152a of the second ring gear 152.

The third planetary gear set 124 is disposed on the side of the second planetary gear set 122 opposite the first planetary gear set 120. Like the second planetary gear set 122, the third planetary gear set 124 includes a third sun gear 200, a third ring gear 202, a third reduction carrier 204 and a third set of planet gears 206. The third sun gear 200 is fixed for rotation with the body 154a of the second reduction carrier 154 and includes a plurality of gear teeth 200a that extend forwardly from the body 154a. An annular second thrust washer 210 is disposed between the second ring gear 152 and the third ring gear 202 and operates to limit the forward movement of the second ring gear 152 and the rearward movement of the third ring gear 202 and the third set of planet gears 206. The second thrust washer 210 includes an aperture 212 through which the third sun gear 200 extends.

The third ring gear 202 is an annular structure having a plurality of gear teeth 202a formed about its interior diameter and an outer radial flange 220 that forms its outer perimeter. A clutch face 222 is formed into the forward surface of the outer radial flange 220. In the particular embodiment illustrated, the clutch face 222 is shown to have an arcuate cross-sectional profile and is further defined by a plurality of peaks 224 and valleys 226 that are arranged relative to one another to form a series of ramps that are defined by an angle of about 18°. Those skilled in the art will understand, however, that clutch faces of other configurations, such as those having a sinusoidal shape, may also be employed. Those skilled in the art will also understand that while the clutch face 222 is shown to be unitarily formed with the third ring gear 202, multi-component configurations may also be employed. Such multi-component configurations include, for example, an annular clutch face ring (not shown) having a rearward facing first side for engaging the third ring gear 202 and a forward facing second side that forms the clutch face 222. Configuration in this latter manner may be advantageous, for example, when it is necessary for the clutch face 222 to have properties or characteristics (e.g., lubricity, hardness, toughness, surface finish) that are different from the properties or characteristics of the third ring gear 202.

The third reduction carrier 204 includes a body 204a, which is formed in the shape of a flat cylinder, and a plurality of cylindrical pins 204b, which extend from the rearward face of the body 204a, and a coupling portion 204c that extends from the forward face of the body 204a. Rotary power transmitted to the third reduction carrier 204 is transmitted through the coupling portion 204c to a coupling member 230 (e.g., a known spindle lock mechanism) that engages the output spindle 20. Those skilled in the art will understand that various other coupling devices and methods may be utilized to couple the third reduction carrier 204 to the output spindle 20, such as a direct coupling of the output spindle 20 to the body 204a of the third reduction carrier 204.

The third set of planet gears 206 includes a plurality of planet gears 206a, each of which being generally cylindrical in shape and having a plurality of gear teeth 206b formed onto its outer perimeter and a pin aperture (not specifically shown) formed through its center. Each planet gear 206a is rotatably supported on an associated one of the pins 204b of the third reduction carrier 204 and is positioned to be in meshing engagement with the gear teeth 202a of the third ring gear 202.

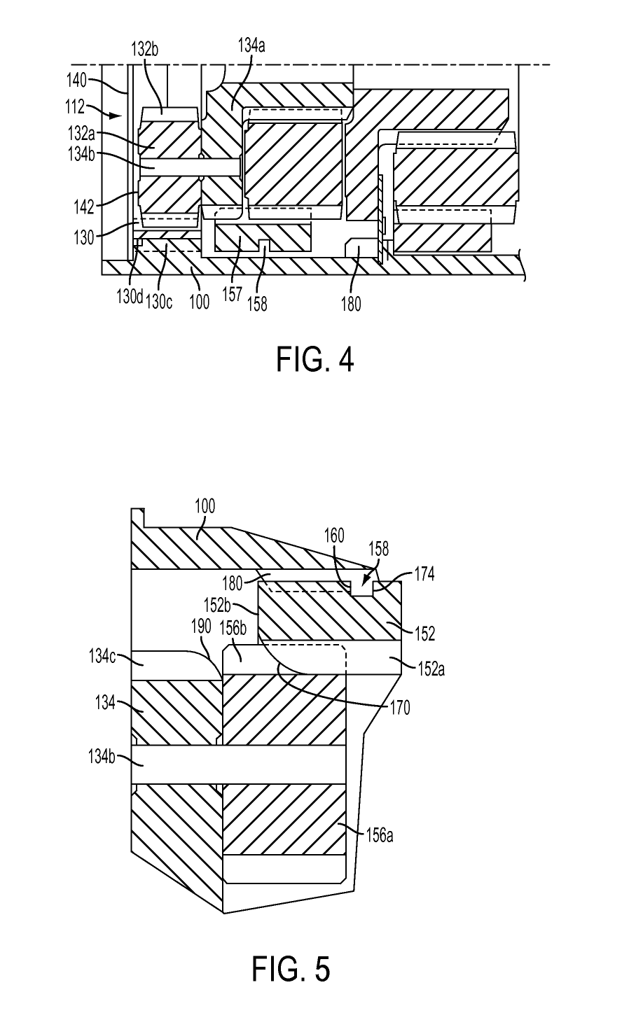

Referring also to FIGS. 4 and 5, the second ring gear 152 is coupled to a speed selector mechanism 60 that is configured to move the second ring gear 152 between a first high speed, low torque position (as shown in FIG. 5) and a second low speed, high torque position (as shown in FIG. 4). An example of such a speed selector mechanism can be found, e.g., in the aforementioned U.S. Pat. No. 7,066,691, which is incorporated by reference. When the second ring gear 152 is in the first position (FIG. 5), the gear case engagement teeth 160 engage mating teeth 180 formed on the inner surface of the gear case 100 to inhibit relative rotation between the second ring gear 152 and the gear case 100. This causes the second ring gear 152 to remain substantially stationary relative to the gear case 100, causing a speed reduction and torque increase across the second stage of the transmission. When the second ring gear 152 is in the second position (FIG. 4), the gear case engagement teeth 160 are axially spaced apart from the mating teeth 180 to thereby permit relative rotation between the second ring gear 152 and the gear case 100. This allows the second ring gear 152 to freely rotate in the gear case 100, which causes the input and output speed and torque to be substantially the same as each other, so that there is substantially no speed reduction or torque increase across the second stage of the transmission. Thus, the transmission assembly provides for two overall speed reduction ratios depending on the position of the second ring gear 152. It should be understood that other types of single speed or multi-speed transmission assemblies could be substituted for the transmission assembly 16.

Clutch Assembly

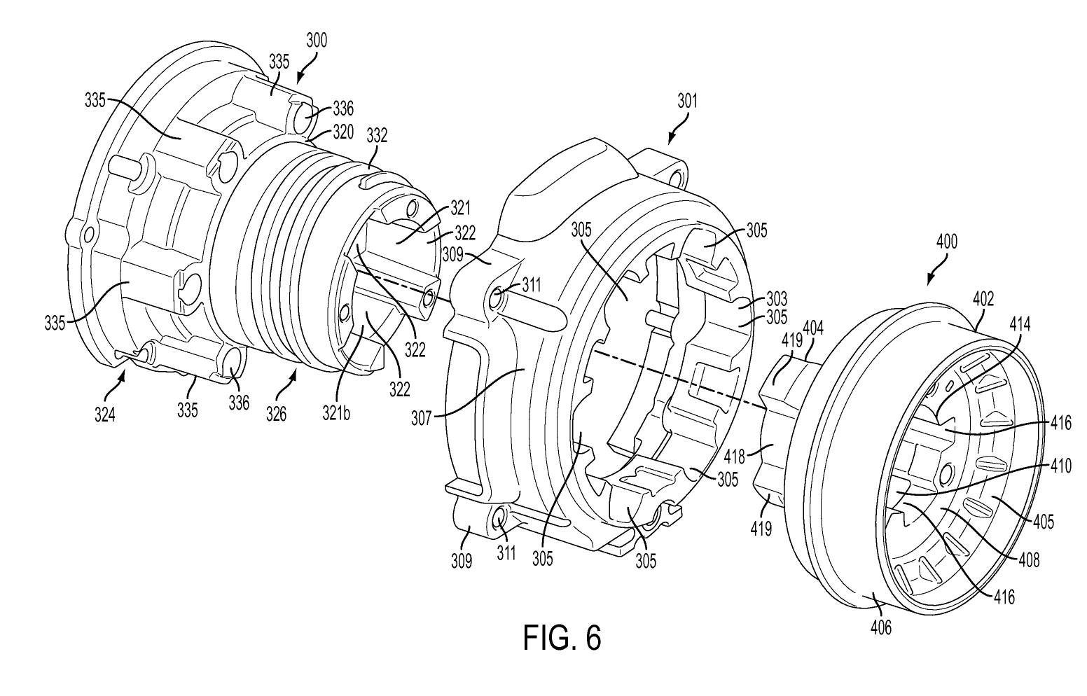

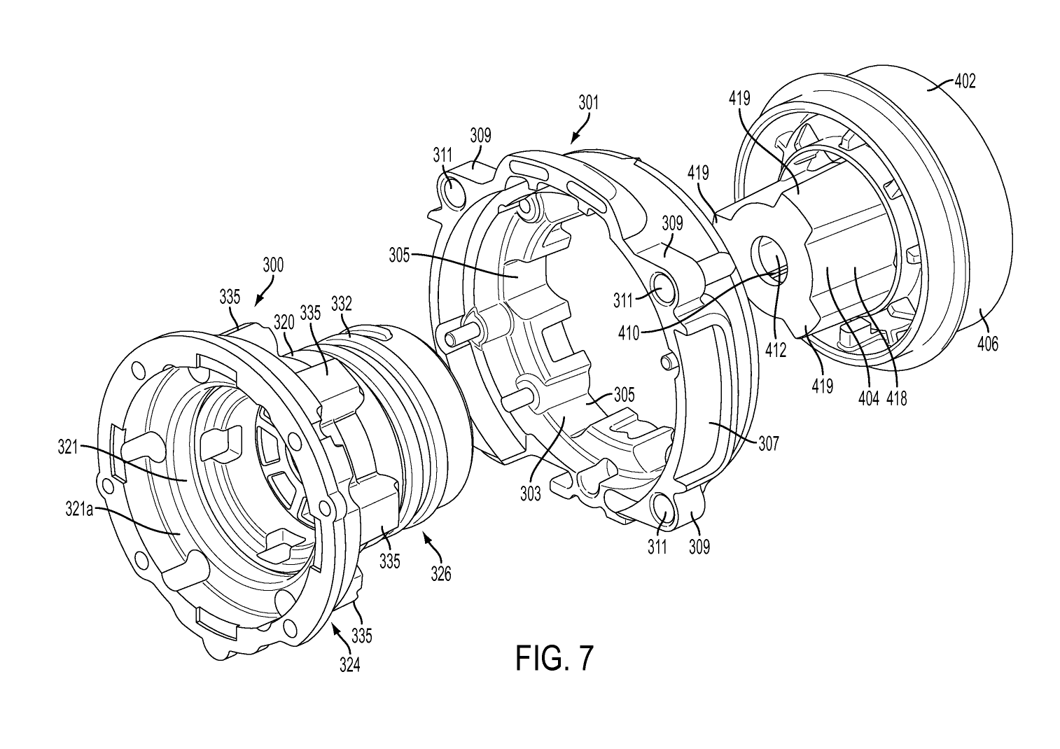

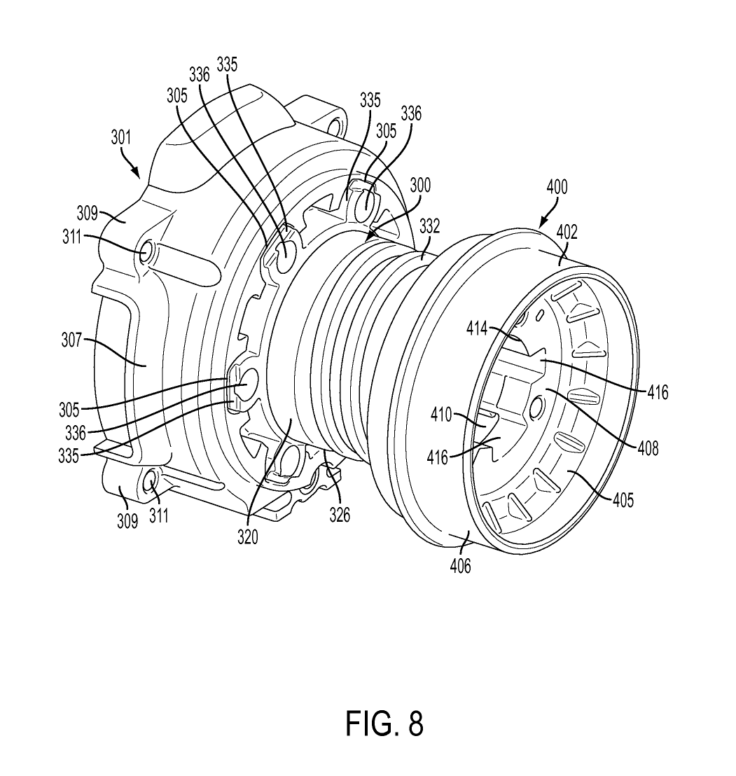

Referring to FIGS. 2-3 and 6-8, the clutch assembly 18 includes a clutch housing 300 and a clutch mechanism 315. The clutch housing 300 includes a hollow wall portion 320 that defines a base portion 324, a nose portion 326 that extends forwardly from the base portion 324, and a hollow cavity or bore 321 that extends along the longitudinal axis of the clutch housing 300. A rearward end portion 321a of the bore 321 is sized to receive the second thrust washer 210, the third ring gear 202 the third reduction carrier 204, the coupling member 230, and a rear end portion of the output spindle 20. A forward end portion 321b of the bore 321 is sized smaller and receives an intermediate portion of the output spindle 20. The nose portion 326, which is smaller in outer diameter than the base portion 324, is generally cylindrical, and has a helical thread 330 that wraps around its perimeter. An interior wall of the nose portion 326 defines a plurality of longitudinal grooves 322 configured to non-rotationally receive the hammer housing 600, as described below. The base portion 324 includes a plurality of bosses 335, each defining a leg aperture 336, the purpose of which is discussed below.

Received over the base portion 324 of the clutch housing 300 is an annular cap 301. The annular cap 301 has a generally cylindrical shape. An interior wall 303 of the annular cap 301 defines a plurality of grooves 305 that are received over the bosses 335 on the clutch housing 300, so that the annular cap 301 does not rotate relative to the clutch housing. As illustrated in FIG. 1, an outer wall 307 of the annular cap 301 is exposed to an exterior of the tool 10. The outer wall 307 includes a plurality of bosses 309, each defining a through opening 311. Each through opening 311 receives a threaded fastener 313 that attaches the annular cap 301 and the clutch housing 300 to the tool housing 12.

The clutch housing 300 and the annular cap 301 are generally composed of different materials having different characteristics. In an embodiment, the clutch housing 300 is composed of a non-metallic material, such as a plastic material (e.g., a partially glass filled nylon material), while the annular cap 301 is composed of a durable metal material (e.g., an aluminum or aluminum alloy material). The non-metallic (e.g., plastic) material of the clutch housing is lightweight, inexpensive, easy to manufacture and mold in a desired shape, and wears well against the other components of the clutch mechanism, which are generally composed of metal. Meanwhile, the annular cap 301 provides a layer over the plastic clutch housing 301 of increased durability from high temperatures, wear and/or abrasion due to the environment in which the tool is used. The annular cap additionally provides a superior substrate for receiving threaded fasteners to attach the cap and clutch housing to the remainder of the power tool; which may reduce the number of fasteners required.

Referring back to FIGS. 2 and 3, the clutch mechanism 315 includes a plurality of locking members in the form of rounded pins 304, an annular clutch plate 306 abutting the pins 304, a spring retainer 390 abutting the clutch plate 306, a compression spring 308 with one end abutting the clutch plate 306, a clutch adjustment ring 310 abutting the other end of the spring 308, and a clutch adjustment sleeve 314 coupled to the clutch adjustment ring 310 for rotation with the clutch adjustment ring 310. The clutch plate 306 and the spring retainer 390 are disposed over the nose portion 326 of the clutch housing 300 and moved axially rearward to push the pins 304 through the leg apertures 336 in the base portion 324 into contact with the clutch face 222.

The compression spring 308 has ground ends, and is disposed over the nose portion 326 of the clutch housing 300 between the adjustment ring 310 and the spring retainer 390. The adjustment ring 310 is an annular structure that is illustrated to include an internal annular flange 380, a threaded portion 382 and an engagement portion 384. The internal annular flange 380 extends around the inner circumference of the adjustment ring 310 and sized somewhat smaller in diameter than the spring 308 but larger than the nose portion 326 of the clutch housing 300. The threaded portion 382 intersects the internal annular flange 380 and is sized to threadably engage the thread form 330 that is formed on the outer diameter of the nose portion 326. The spring 308 is received inside of the engagement portion 384 and abuts against the flange 380. The engagement portion 384 is configured to permit the adjustment ring 310 to be rotatably coupled to the clutch adjustment sleeve 314 and well as to move axially within the clutch adjustment sleeve 314. In the example provided, the engagement portion 384 includes a plurality of engagement teeth 384a that are formed about the outer perimeter of the adjustment ring 310. The spring retainer 390 has an annular shaped body with an outer wall having a plurality of splines 397, and an inner wall configured to receive an end of the spring 308 and rotate relative to the spring 308. The engagement teeth 384a of the adjustment ring 310 and the splines 397 of the spring retainer 390 are configured to engage engagement teeth 422 on the clutch adjustment sleeve 314, as described below. The spring retainer 390 is more completely described in U.S. patent application Ser. No. 13/828,149, filed Mar. 14, 2013, which is incorporated by reference.

The clutch adjustment sleeve 314 includes a hollow sleeve that shrouds the clutch plate 306, the spring retainer 390, the spring 308, and the adjustment ring 310. The clutch adjustment sleeve 314 extends forwardly of the base portion 324 and includes a gripping surface 420 that is formed on its outer perimeter. The gripping surface 420 is contoured to permit the user of the power tool 10 to rotate the clutch adjustment sleeve 314 about the longitudinal axis of the power tool 10 to adjust the setting of the clutch mechanism 18. A plurality of mating engagement teeth 422 are formed onto the inner diameter of the clutch adjustment sleeve 314 which are sized to engage the engagement teeth 384a of the adjustment ring 310 and the splines 397 of the spring retainer 390. The mating engagement teeth 422 are relatively longer than the engagement teeth 384a and splines 397 combined, and as such, permit the engagement teeth 384a and splines 397 to axially slide along the mating engagement teeth 422 along the longitudinal axis of the power tool 10 when the clutch adjustment sleeve 314 is rotated. In addition, the engagement between the engagement teeth 422 of the clutch sleeve 314 and the engagement teeth 384a and the splines 397 cause the clutch sleeve 314, the adjustment ring 310, and the spring retainer 390 to rotate together, substantially in unison.

Rotation of the clutch adjustment sleeve 314 relative to the clutch housing 300 causes the adjustment ring 310 and the spring retainer 390 to rotate about the clutch housing 300. The spring retainer 390 remains substantially stationary axially relative to the clutch housing 300 when it is rotated. The adjustment ring 310 ring moves axially relative to the clutch housing 300 when it is rotated, due to the engagement of the threaded portion 384 with the thread 330 on the clutch housing 300. The axial movement of the adjustment ring 310 alters the amount by which the spring 308 is compressed between the adjustment ring 310 and the spring retainer 390. Because the adjustment ring 310 and the spring retainer 390 tend to rotate together in unison, the spring 308 tends not to become twisted as the adjustment ring 310 and spring retainer 390 rotate.

When the power tool 10 is operated and the torque that is exerted through the gear teeth 202a of the third ring gear 202 does not exceed the holding force exerted by the spring 308 and balls 304 on the clutch face 22 of the third ring gear 202, the third ring gear 202 remains rotationally fixed relative to the housing. When this happens, the third sun gear 200 causes the third set of planet gears 206 to rotate on their axes and orbit the sun gear 200. The orbiting of the third set of planet gears 206 causes the third reduction carrier 204 to rotate and transmit torque to the output spindle 20.

When the power tool 10 is operated and the torque that is exerted through the gear teeth 202a of the third ring gear 202 exceeds the holding force exerted by the spring 308 and balls 304 on the clutch face, the peaks 224 of the clutch face 222 ride over the balls 304 to enable the third ring gear 202 to rotate relative to the housing. When this happens, the third sun gear 200 causes the third set of planet gears 206 to rotate on their axes but not to oribit the sun gear 200 in any substantial manner. Thus, the third reduction carrier 204 substantially stops rotating, and torque transmission to the output spindle 20 is greatly reduced and/or essentially interrupted.

Hammer Assembly

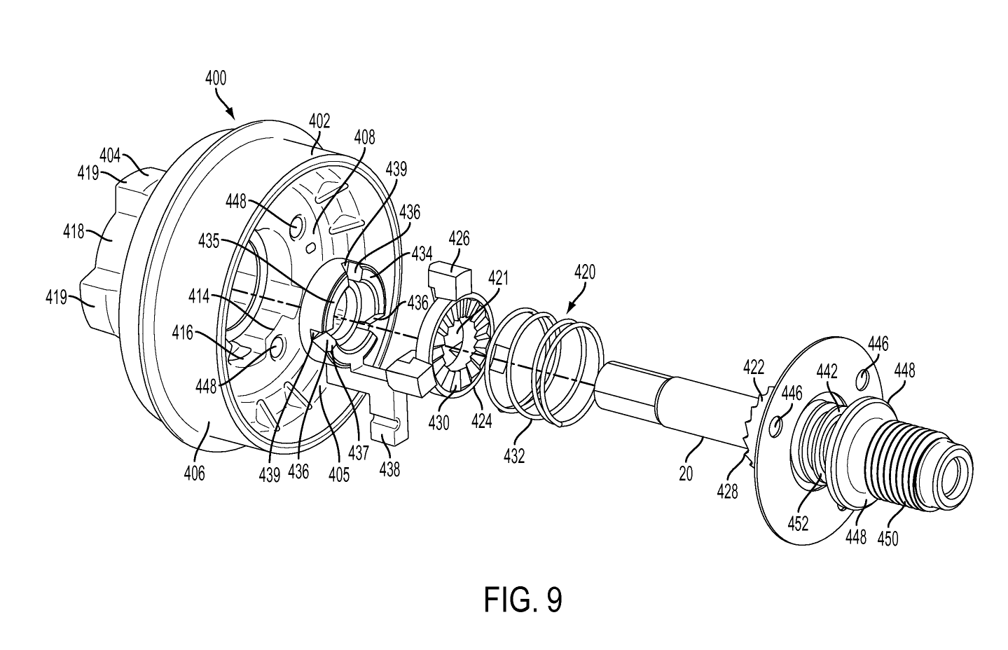

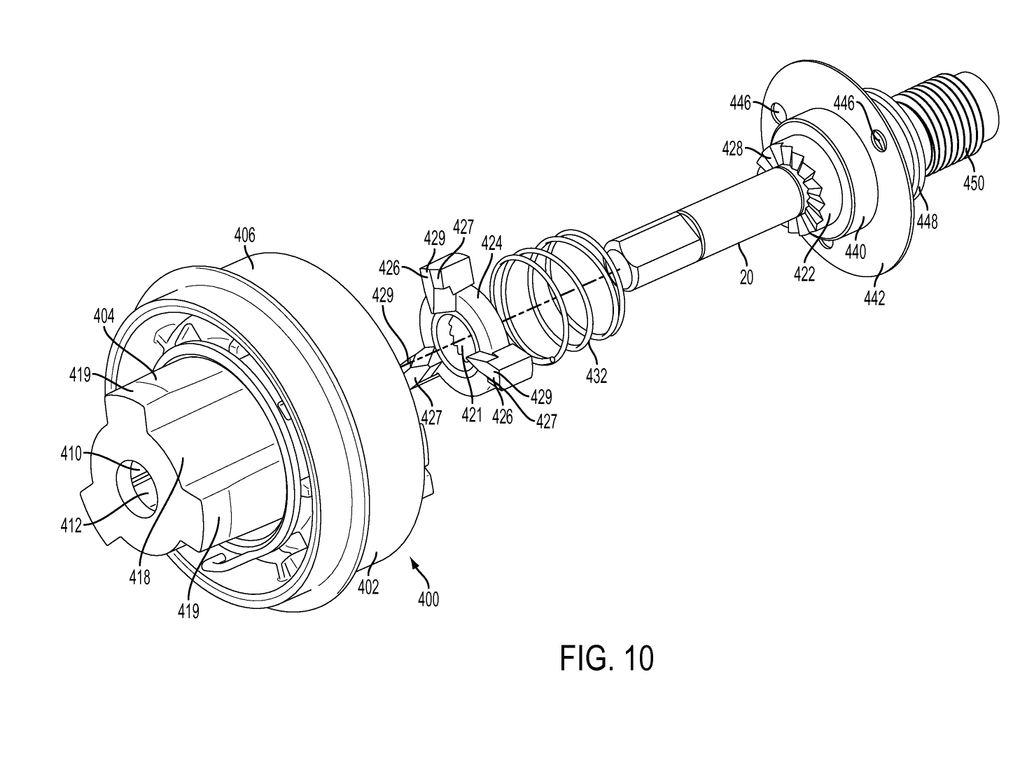

Referring to FIGS. 1-2 and 6-10, the hammer assembly 19 comprises a hammer housing 400 and a hammer mechanism 420. The hammer housing 400 includes a large diameter substantially cylindrical front portion 402, and a smaller diameter substantially tubular rear portion 404. The front portion 402 includes a base wall 408 and an annular flange 406 extending forward of the base wall 408, defining a recess 405. The rear portion 404 includes an inner bore 410 extending to through the base wall 408. The inner bore 410 has a round rear portion 412, and a front portion 414 having a plurality of longitudinal grooves 416. The rear portion also has an exterior wall 418 defining a plurality of longitudinal projections 419. When the tool 10 is assembled, the rear portion 404 of the hammer housing 400 is received inside of the bore 321 of the clutch housing 300, with the longitudinal projections 419 on the hammer housing 400 engaging the longitudinal grooves 322 in the clutch housing 300 so as to prevent rotation of the hammer housing 400 relative to the clutch housing 300. The inner bore 410 and the recess 405 receive and support the hammer mechanism 420, as described below. As shown in FIG. 1, the annular flange 406 of the hammer housing 400 is exposed to the exterior of the tool and is composed of a material that is a good heat conductor, such as a heat conductive metal (e.g., an aluminum or aluminum alloy material). Thus, the hammer housing 400 functions as a heat sink for the hammer mechanism 420 to dissipate heat generated by the hammer mechanism 420 and to reduce or eliminate melting, deformation, or other heat related damage the clutch housing 300.

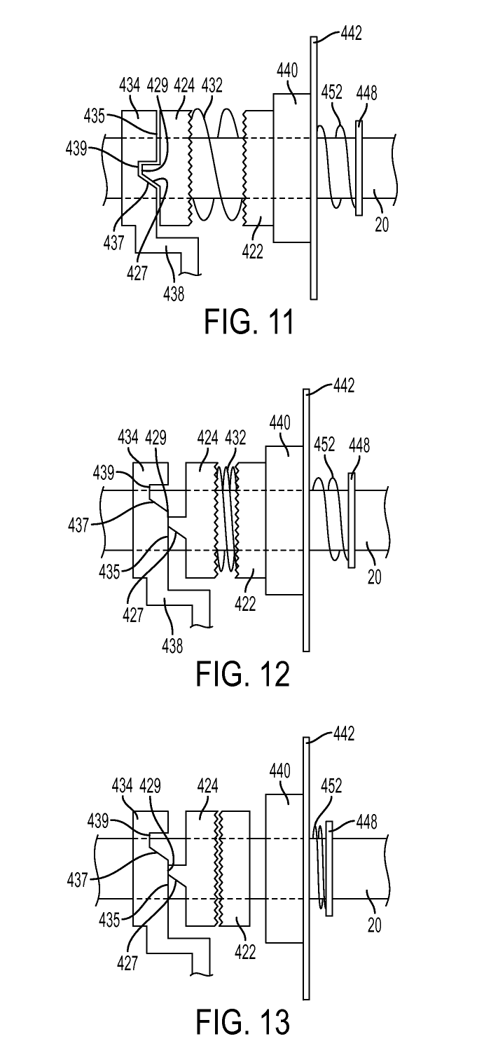

Referring also to FIGS. 11-13, the hammer mechanism 420 is similar in design to the hammer mechanisms described in the aforementioned U.S. Pat. Nos. 5,704,433 and 7,314,097, which are incorporated by reference. The hammer mechanism 420 includes a rotating ratchet wheel 422 that is fixedly connected to the output spindle 20 to rotate with the output spindle 20, and fixed ratchet wheel 424 that remains rotationally stationary relative to the output spindle 20 when the output spindle 20 rotates. Disposed between the rotating ratchet wheel 422 and the fixed ratchet wheel 424 is a first compression spring 432 configured to bias the fixed ratchet wheel 424 in a rearward direction away from the rotating ratchet wheel 422. The rotating ratchet wheel 422 and the fixed ratchet wheel 424 each have ratchet teeth 428, 430 that face one another and are configured to selectively engage each other to impart axial impacts to the output spindle 20 as described below.

The fixed ratchet wheel 424 has an annular body with radially extending ears 426 that are received in the grooves 416 of the hammer housing 400. The ears 426 and grooves 416 keep the fixed ratchet wheel 420 rotationally stationary relative to the hammer housing 400, while allowing the fixed ratchet wheel 420 to move axially relative to the output spindle 20. Each ear 426 also has an angled cam surface 427 and a flat surface 429. The fixed ratchet wheel 424 also has a round central opening 421 that receives the output spindle 20 so that the output spindle 20 can rotate and move axially relative to the fixed ratchet wheel 424.

Disposed behind the fixed ratchet wheel is an annular cam plate 434. The cam plate 535 has an annular body with a substantially planar front face 435, and a plurality of cam grooves 436 formed in the front face 435. Each cam groove 436 includes an angled cam cam surface 437, and a flat surface 439. The cam grooves 436 are configured to receive the cam projections 438 on the ears 426 with the cam angled cam surfaces 437 of the cam plate 434 abutting the angled cam surfaces 427 of the stationary ratchet wheel 424. Coupled to the cam plate 434 is a leg 438 that projects radially outward and is coupled to the clutch adjustment sleeve 314 in a known matter so that selective rotation of the adjustment sleeve 314 between certain positions causes rotation of the cam plate 434, and axial movement of the stationary ratchet wheel 424, as described in more detail below.

The rotating ratchet wheel 422 comprises an annular body and is fixedly connected to the output spindle 20. Disposed in front of the rotating ratchet wheel 428 is a retention plate 442 that is fixedly connected to the hammer housing 400 by one or more threaded fasteners 444 that are received through apertures 446 in the retention plate 442 and apertures 448 in the hammer housing 400. The retention plate 442 includes a central opening that receives the output spindle 20 so that the output spindle 20 can rotate and move axially relative to the retention plate 442. Disposed between the retention plate 442 and the fixed ratchet wheel 428 is a bearing sleeve 444 that supports the output spindle 20 for rotation, and that enables axial movement of the output spindle 20. Fixedly coupled to the output spindle 20, in front of the retention plate 442, is a flange 448 and a threaded end portion 450 for connecting the chuck 22 to the output spindle 20. Disposed between the flange 448 and the retention plate 442 is a second compression spring 452 that biases the flange 448 and, thus the output spindle, axially forward away from the retention plate 442.

In operation, rotation of the clutch adjustment sleeve 314 enables selection among one or more clutch modes (where the clutch mechanism is active, and the hammer mechanism is inactive), a drill mode (where the clutch mechanism and the hammer mechanism are both inactive), and a hammer mode (where the clutch mechanism is inactive and the hammer mechanism is active). Referring to FIG. 11, in the clutch modes or in the drill mode, the cam plate 434 is positioned in a first position. In the first position of the cam plate 434, the radial ears 426 of the stationary ratchet wheel 424 are aligned with the grooves 436 of the cam plate 434. The first spring 432 biases the stationary ratchet wheel 424 rearwardly so that the angled cam surfaces 427, 437 abut. In this position, the stationary ratchet wheel 424 is positioned sufficiently far enough away from the rotating ratchet wheel 422 so that the ratchet teeth 438, 430 of the ratchet wheels cannot engage each other, even when axial bias causes rearward movement of the output spindle 20. Thus, in this mode, no axial impacts will be applied to the output spindle 20.

Referring to FIG. 12, in the hammer mode of operation, the clutch adjustment sleeve 314 causes the cam plate 434 to rotates by a predetermined amount (e.g., approximately 10 to 15 degrees). The cam surfaces 437 on the cam plate 434 engage the cam surfaces 439 on the stationary ratchet wheel 424 to push the stationary ratchet wheel 424 axially forward against the biasing force of the spring 432 toward the rotating ratchet wheel 422, until the flat surfaces 429 of the stationary ratchet wheel 424 abut against front surface 435 of the cam plate 434. The ratchet teeth 430, 428 are now close enough to engage each other. Referring to FIG. 13, when axial bias is applied to the output spindle 20, the output spindle 20 and rotating ratchet wheel 422 move axially rearward against the force of the second compression spring 452, causing the ratchet teeth 430, 428 to engage each other. As the output spindle 20 continues to rotate, the ratchet teeth 428, 430 ride over each other. As this happens the ratchet teeth 430 of the stationary ratchet wheel 424 apply axial impacts to the ratchet teeth 428 of the rotating ratchet wheel 422, causing the output spindle 420 to rapidly move axially forward and backwards against the force of the second spring 452. The impacts of the ratchet teeth 430, 428 generate a great deal of heat, which is transferred to the atmosphere by the heat conductive hammer housing 400.

Numerous modifications may be made to the exemplary implementations described above. For example, the power tool may be a corded power tool. The transmission may have a different number of speed settings, and a different number of planetary stages. The transmission may have different types of gears such as parallel axis gears. The clutch mechanism may use a plurality of balls or other components instead of the rounded pins. The clutch settings may not be adjustable. The power tool may include a separate mode change collar and clutch setting collar. The tool bit holder may be other than a chuck, such as a quick-release bit holder. The hammer mechanism may have a different type of configuration. These and other implementations are within the scope of the following claims.

What is claimed is:

1. A power tool comprising:
a tool housing;
an output spindle;
a motor received in the tool housing;
a transmission coupled to the motor and configured to transmit torque from the motor to the output spindle;
a clutch assembly including a clutch mechanism configured to interrupt torque transmission from the transmission to the output spindle when an output torque exceeds a threshold, and a clutch housing composed of a non-metallic material and supporting at least a portion of the clutch mechanism; and
a hammer assembly including a hammer mechanism configured to apply axial impacts to the output spindle when the hammer mechanism is engaged, and a hammer housing composed of a heat conductive material and supporting at least a portion of the hammer mechanism, wherein the hammer housing is at least partially disposed inside of a portion of the clutch housing.

2. The power tool of claim 1, wherein the clutch assembly and the hammer assembly are disposed between the transmission and the output spindle.

3. The power tool of claim 1, wherein the clutch mechanism comprises a clutch face fixedly connected to a portion of the transmission, a pressing member selectively engaging the clutch face, and a biasing member configured to bias the pressing member against the clutch face, wherein torque transmission from the transmission to the output spindle is effectively interrupted when the output torque overcomes a biasing force exerted by the biasing member and the pressing member against the clutch face.

4. The power tool of claim 3, wherein the clutch mechanism further comprises an adjustment sleeve configured to adjust the biasing force exerted by the biasing member and the pressing member on the clutch face.

5. The power tool of claim 1, wherein the hammer mechanism comprises a rotating ratchet wheel fixedly coupled to the output spindle, a stationary ratchet wheel non-rotatably coupled to the hammer housing, and a spring biasing the rotating ratchet wheel away from the stationary ratchet wheel, wherein the stationary ratchet wheel and the rotating ratchet wheel are configured to engage each other against the force of the spring when axial bias is applied to the output spindle, causing axial impacts to be applied to the output spindle.

6. The power tool of claim 5, further comprising a cam plate configured to selectively axially move at least one of the stationary ratchet wheel and the rotating ratchet wheel to prevent engagement of the stationary ratchet wheel and the rotating ratchet wheel to prevent axial impacts from being applied to the output spindle.

7. The power tool of claim 1, wherein at least a portion of the hammer housing is exposed to an exterior of the power tool.

8. The power tool of claim 1, further comprising an annular cap disposed over the rear portion of the clutch housing, wherein at least a portion of the annular cap is exposed to an exterior of the power tool.

9. The power tool of claim 8, wherein the annular cap comprises a metal material.

10. The power tool of claim 1, wherein the clutch housing comprises a smaller diameter nose portion and a larger diameter base portion, and the hammer housing comprises a larger diameter front portion and a smaller diameter rear portion that is at least partially disposed inside the nose portion of the clutch housing.

11. The power tool of claim 1, wherein the non-metallic material comprises a plastic material.

12. The power tool of claim 1, wherein the heat conductive material comprises a metal material.

13. A power tool comprising:
a tool housing;
a motor received in the tool housing;
an output spindle at least partially received in the tool housing;
a transmission coupled to the motor and configured to transmit torque from the motor to the output spindle;
a clutch assembly including a clutch housing with a nose portion and a base portion, a clutch face connected to a portion of the transmission, a pressing member configured to selectively engage the clutch face, and a biasing member configured to bias the pressing member against the clutch face, wherein torque transmission from the transmission to the output spindle is interrupted when an output torque overcomes a biasing force exerted by the biasing member against the pressing member, enabling the clutch face to move relative to the pressing member; and
a hammer assembly including a hammer housing with a rear portion at least partially received in the nose portion of the clutch housing and a front portion at least partially exposed to an exterior of the power tool, a rotating ratchet wheel fixedly coupled to the output spindle and received in the rear portion, a stationary ratchet wheel non-rotatably coupled to the hammer housing and received in the rear portion, and a spring biasing the rotating ratchet wheel away from the stationary ratchet wheel, wherein the stationary ratchet wheel and the rotating ratchet wheel are configured to engage each other against the force of the spring when axial bias is applied to the output spindle, causing axial impacts to be applied to the output spindle.

14. The power tool of claim 13, wherein the clutch housing and the hammer housing are composed of different materials.

15. The power tool of claim 14, wherein the hammer housing is composed of a heat conductive material.

16. The power tool of claim 15, wherein the clutch housing is composed of a plastic material.

17. The power tool of claim 13, wherein the rotating ratchet wheel and the stationary ratchet wheel are nested inside of the nose portion of the clutch housing.

18. The power tool of claim 13, further comprising an annular cap disposed over the base portion of the clutch housing, the annular cap being at least partially exposed to an exterior of the power tool.

19. The power tool of claim 18, wherein the annular cap comprises a metal material.

20. A power tool comprising:
a tool housing;
a motor received in the tool housing;
an output spindle at least partially received in the tool housing;
a transmission coupled to the motor and configured to transmit torque from the motor to the output spindle;
a clutch assembly including a clutch mechanism configured to interrupt torque transmission from the transmission to the output spindle when an output torque exceeds a threshold, and a clutch housing composed of a non-metallic material and supporting at least a portion of the clutch mechanism; and
an annular cap disposed over the base portion of the clutch housing, the annular cap being at least partially exposed to an exterior of the hammer drill and comprising a metal material.
